(19) United States
(12) Patent Application Publication
(10) Pub. No.: US 2009/0058643 A1
(43) Pub. Date: Mar. 5, 2009

(54) Alarm apparatus, system and/or method for securing an article

(76) Inventor: Jim Groth, Poplar Grove, IL (US)

Correspondence Address: PATENTS+TMS, P.C., 2849 W. ARMITAGE AVE., CHICAGO, IL, 60647, US

(21) Appl. No.: 11/895,947

(22) Filed: Aug. 28, 2007

(51) Int. Cl. G08B 13/12

(52) U.S. Cl. 340/568.1

(57) ABSTRACT

An alarm apparatus, a system and/or a method for securing an article are provided. The alarm apparatus, the system and/or the method may operate as an alarm system that may prevent a theft and/or a removal of the article. The alarm apparatus, the system and/or the method may have a loop alarm that may monitor whether the article is secured to a display with a tether. The loop alarm may be attached to the article, such as, for example, a portable electronic device. The article may be on display and/or may be used, manipulated, tested and/or transported by consumers. The loop alarm may have a two conductor cable that may tether the loop alarm and/or the article to a cable housing. The loop alarm may enter an alarm mode when the loop alarm detects that the loop alarm has been detached from the article and/or when the loop alarm detects that the two conductor cable has been cut and/or damaged. The loop alarm may produce an audible indicator and/or a visible indicator of the alarm mode from a location of the article.

### BACKGROUND OF THE INVENTION

The present invention generally relates to an alarm apparatus, a system and/or a method for securing an article. More specifically, the present invention relates to an alarm apparatus, a system and/or a method that may operate as an alarm system that may prevent a theft and/or a removal of the article from a display stand. A tether may secure the article to the display stand. The self-contained alarm apparatus, the system and/or the method may have a loop alarm that may monitor whether the article is secured to the display with the tether. The loop alarm may be attached to the article, such as, for example, a portable electronic device. The article may be on display and/or may be used, manipulated, tested and/or transported by consumers in an environment, such as, for example, a retail store. The loop alarm may have a two conductor cable that may tether the loop alarm and/or the article to a cable housing that may store and/or may distribute excess cable. The cable housing may be attached to the display. The loop alarm may be programmed to enter an alarm mode when the loop alarm detects that the article is not tethered to the display and/or to the cable housing. The loop alarm may have an audible indicator and/or a visible indicator that may indicate the alarm mode.

It is generally known that retailers of articles provide one or more of the articles as samples that allow consumers to interact with the articles. The samples may be located on or near a display for the article wherein pricing information and product availability may be displayed. Further, power connections may be provided at the display to power the samples and/or security systems associated with the samples. Data connections may be provided at the display to provide Internet access and/or other like network connectivity to the samples. Moreover, security tethers may be provided at the display to mechanically anchor the samples to the display. Samples are secured to prevent removal, theft and/or damage. Nonetheless, the presence of samples may be essential to marketing and/or sales of the article. Therefore, it is important for retailers to maintain an availability of the samples and/or to control a location of the samples to allow consumers to have exposure to the articles.

As a result, known security systems are provided and/or are used by retailers to secure a sample to its display and/or to alert security personnel of theft, destruction and/or tampering of the sample. The known security systems are typically electronically connected by means of wires to sensors attached to the samples. The wires are used to power the samples and/or to communicate with a control box at or near the display. The sensors of the known security systems typically detect tampering with the sample and/or removal of the sensor from the sample. The control box of the known security systems monitors an output of the sensor and/or a connection between the article and the display. Upon theft, destruction and/or tampering of the article, the control box of the known security systems often sounds an alarm at or near the display stand where the control box may be located. Still further, the control box of the known security systems typically provides power to the sensors that may be attached to the samples. Known security systems, however, are often difficult to install, bulky and/or expensive to produce and/or maintain. Known security systems may have a tether retrieval system that may extract and/or retract the wires connected to samples. The tether retrieval systems are typically located outside of the control box. Moreover, the known security systems may require external power that must be delivered from the control box through the tether retrieval system to the sensors.

A need, therefore, exists for an alarm apparatus, a system and/or a method for securing an article. Additionally, a need exists for an alarm apparatus, a system and/or a method that may operate as an alarm system that may prevent a theft and/or a removal of the article. Further, a need exists for an alarm apparatus, a system and/or a method that may have a loop alarm that may monitor whether the article is secured to the display with a tether. Still further, a need exists for an alarm apparatus, a system and/or a method that may be self-powered. Still further, a need exists for an alarm apparatus, a system and/or a method that may have a two conductor cable that may connect the loop alarm and/or the article to a cable housing. Still further, a need exists for an alarm apparatus, a system and/or a method that may have a closed loop circuit that may be wired from the loop alarm through a tether into the cable housing and back through the tether to the loop alarm. Moreover, a need exists for an alarm apparatus, a system and/or a method that may produce an audible indicator and/or a visible indicator of an alarm mode that may be emitted from the loop alarm in a location of the article at the time of the alarm mode.

### SUMMARY OF THE INVENTION

The present invention generally relates to an alarm apparatus, a system and/or a method for securing an article. More specifically, the present invention relates to an alarm apparatus, a system and/or a method that may operate as an alarm system that may prevent a theft and/or a removal of the article. The alarm apparatus, the system and/or the method may have a loop alarm that may monitor whether the article is secured to the display with a tether. The loop alarm may be self-powered by a battery and/or other like power source. The loop alarm may be attached to the article. The article may be a portable electronic device, such as, for example, a cellular telephone, an mp3 player, a camera, a camcorder, a PDA, a gaming device, a handheld GPS system, an e-book reader, a laptop computer, a satellite radio, a remote control and/or the like. The article may be on display and/or may be used, manipulated, tested and/or transported in an environment, such as, for example, a retail store.

The loop alarm may have an on/off switch for enabling and/or for disabling the loop alarm. The loop alarm may have a plunger switch for arming the loop alarm and/or for sensing detachment of the loop alarm from the article. The loop alarm may have a built-in power source, such as, for example, a battery and/or the like. The loop alarm may have a printed circuit board and/or a printed circuit board assembly for monitoring and/or for controlling electrical components of the loop alarm. The loop alarm may have a piezoelectric horn for sounding an alarm.

The loop alarm may have a two conductor cable that may physically connect the loop alarm and/or the article to a cable housing. The cable housing may be affixed, for example, to a display stand in a retail store. The two conductor cable may be a single cable that may have two or more conductive wires that may be insulated within the two conductor cable. The conductive wires may be electrically and/or mechanically connected to the printed circuit board and/or the printed circuit board assembly of the loop alarm at a first end of the two conductor cable. The conductive wires may be shorted together at a second end of the two conductor cable. Moreover, the second end of the two conductor cable may be affixed to a spool that may be encased in the cable housing. The cable housing may have a spring attached to the spool to resist a rotation of the spool in a first direction while loading the spring. The spring may assist a rotation of the spool in a second direction opposite to the first direction unloading the spring.

The loop alarm may enter an alarm mode when the loop alarm detects an open circuit. The open circuit may be created by, for example, removal of the loop alarm from the article which may extend the plunger switch. The open circuit may be created by, for example, a severing of one and/or more of the conductive wires within the two conductor cable. During the alarm mode, the loop alarm may produce, for example, an audible indicator and/or a visible indicator that may alert security personnel that the article may no longer be attached to the display.

To this end, in an embodiment of the present invention, an alarm apparatus for securing an article is provided. The alarm apparatus has a loop alarm having an indicator, a switch, a two conductor cable and a printed circuit board wherein the indicator, the switch and the two conductor cable are electrically connected to the printed circuit board wherein the switch has a first position that forms a closed circuit wherein the loop alarm enters an alarm mode and activates the indicator when the switch is not in the first position. Further, the alarm apparatus has a cable housing having a cover that defines an interior wherein the two conductor cable retracts into the housing.

In an embodiment, the alarm apparatus has an on/off switch on the loop alarm wherein the on/off switch is recessed within a slot on the loop alarm wherein the on/off switch enables and disables the loop alarm.

In an embodiment, the indicator is an audible indicator that provides an audible signal.

In an embodiment, the indicator is a visible indicator that provides a visible signal.

In an embodiment, the alarm apparatus has an adhesive layer on the loop alarm wherein the adhesive layer attaches the loop alarm to the article.

In an embodiment, the switch is a plunger that is depressed in the first position.

In an embodiment, the alarm apparatus has an insulating tube around the two conductor cable.

In an embodiment, the alarm apparatus has a spool within the interior of the cable housing.

In an embodiment, the alarm apparatus has a spring within the interior of the cable housing.

In an embodiment, the alarm apparatus has a battery within the loop alarm wherein the battery provides power to the loop alarm.

In another embodiment of the present invention, a system for securing an article is provided. The system has a loop alarm for monitoring an attachment of the loop alarm to the article and further wherein the loop alarm monitors an attachment of the loop alarm to a two conductor cable wherein the loop alarm enters an alarm mode when the loop alarm is detached from the article wherein the loop alarm enters an alarm mode when the two conductor cable is severed wherein the loop alarm produces an audible indicator associated with the loop alarm wherein the audible indicator provides an audible signal indicative of the alarm mode. Further, the system has a cable housing having a spool and a spring wherein a length of the two conductor cable between a first end of the two conductor cable and a second end of the two conductor cable is wound around the spool wherein the spring resists an unwinding of the length of the two conductor cable from the spool wherein the spring assists a winding of the length of the two conductor cable onto the spool.

In an embodiment, the system has a plunger on the loop alarm wherein the plunger is depressed during the attachment of the loop alarm to the article.

In an embodiment, the system has a horn on the loop alarm wherein the horn produces the audible indicator.

In an embodiment, the system has a switch on the loop alarm wherein the switch enables and disables the loop alarm.

In an embodiment, the system has a visual indicator that provides a visual signal indicative of the alarm mode.

In an embodiment, the system has a power source within the loop alarm.

In another embodiment of the present invention, a method for securing an article is provided. The method has the step of providing a loop alarm that monitors an attachment of the loop alarm to the article and an attachment of the loop alarm to a two conductor cable wherein the two conductor cable has a first end and a second end wherein the second end is in a position opposite to the first end forming a length of the two conductor cable wherein the first end of the two conductor cable is electrically connected to the loop alarm wherein the two conductor cable has a first conductive wire and a second conductive wire. Further, the method has the step of shorting the first conductive wire to the second conductive wire at the second end of the two conductor cable. Further, the method has the step of attaching the second end of the two conductor cable in a cable housing. Further, the method has the step of activating the loop alarm. Further, the method has the step of attaching the loop alarm to the article.

In an embodiment, the method has the step of deactivating the loop alarm.

In an embodiment, the method has the step of winding the two conductor cable in the cable housing between the first end of the two conductor cable and the second end of the two conductor cable.

In an embodiment, the method has the step of providing power to the loop alarm.

It is, therefore, an advantage of the present invention to provide an alarm apparatus, a system and/or a method for securing an article.

Another advantage of the present invention is to provide an alarm apparatus, a system and/or a method for securing an article that may operate as an alarm system that may prevent a theft and/or a removal of the article.

And, another advantage of the present invention is to provide an alarm apparatus, a system and/or a method for securing an article that may have a loop alarm that may monitor whether the article is attached to a display stand.

Yet another advantage of the present invention is to provide an alarm apparatus, a system and/or a method for securing an article that may have a two conductor cable that may attach the loop alarm and/or the article to a cable housing.

A further advantage of the present invention is to provide an alarm apparatus, a system and/or a method for securing an article that may enter an alarm mode when the loop alarm is removed from the article and/or when the article and/or the loop alarm has been removed from the display stand and/or the cable housing.

Moreover, an advantage of the present invention is to provide an alarm apparatus, a system and/or a method for securing an article that may produce an audible indicator and/or a visible indicator of an alarm mode from a location of the article.

And, another advantage of the present invention is to provide an alarm apparatus, a system and/or a method for securing an article that may be powered at the article-end of the system.

Yet another advantage of the present invention is to provide an alarm apparatus, a system and/or a method for securing an article that may be easy to install, lightweight, small and/or inexpensive to produce and/or to maintain.

Another advantage of the present invention is to provide an alarm apparatus, a system and/or a method for securing an article that may have a closed loop circuit that may be wired from the loop alarm through a two conductor cable into a cable housing and back through the two conductor cable to the loop alarm.

Yet another advantage of the present invention is to provide an alarm apparatus, a system and/or a method for securing an article wherein the article may be a portable electronic device, such as, for example, a cellular telephone, an mp3 player, a camera, a camcorder, a PDA, a gaming device, a handheld GPS system, a laptop computer, a satellite radio, a remote control, an e-book reader and/or the like.

A still further advantage of the present invention is to provide an alarm apparatus, a system and/or a method for securing an article wherein the article may be on display and/or may be used, manipulated, tested and/or transported in a store.

Moreover, an advantage of the present invention is to provide an alarm apparatus, a system and/or a method for securing an article wherein the loop alarm may have an on/off switch for enabling and/or for disabling the loop alarm.

And, another advantage of the present invention is to provide an alarm apparatus, a system and/or a method for securing an article wherein the loop alarm may have a plunger switch for arming the loop alarm and/or for sensing detachment of the loop alarm from the article.

Yet another advantage of the present invention is to provide an alarm apparatus, a system and/or a method for securing an article wherein the loop alarm may have a built-in power source.

Moreover, an advantage of the present invention is to provide an alarm apparatus, a system and/or a method for securing an article wherein the loop alarm may have a piezoelectric horn.

And, another advantage of the present invention is to provide an alarm apparatus, a system and/or a method for securing an article that may have a two conductor cable that may have conductive wires that may be electrically and/or mechanically connected to a printed circuit board and/or a printed circuit board assembly of the loop alarm. Further, the conductive wires may be shorted together. Moreover, the two conductor cable may be affixed to the cable housing.

Yet another advantage of the present invention is to provide an alarm apparatus, a system and/or a method for securing an article wherein the loop alarm may detect an open circuit.

Additional features and advantages of the present invention are described in, and will be apparent from, the detailed description of the presently preferred embodiments and from the drawings.

### BRIEF DESCRIPTION OF THE DRAWINGS

FIG. 1 illustrates a top view of an alarm apparatus and system for securing an article with the cover of the cable housing removed in an embodiment of the present invention.

FIG. 2 illustrates a cross-sectional view of a two conductor cable with a short that creates a closed circuit in an embodiment of the present invention.

FIG. 3 illustrates a side view of a spool, a spring and a two conductor cable in an embodiment of the present invention.

FIG. 4 illustrates a bottom view of a loop alarm and a two conductor cable in an embodiment of the present invention.

FIG. 5 illustrates a black box diagram of a loop alarm in an embodiment of the present invention.

### DETAILED DESCRIPTION OF THE PRESENTLY PREFERRED EMBODIMENTS

The present invention generally relates to an apparatus, a system and/or a method for securing an article. More specifically, the present invention relates to an alarm apparatus, a system and/or a method that may operate as an alarm system that may prevent a theft and/or a removal of the article. The alarm apparatus, the system and/or the method may monitor whether the loop alarm is attached to the article and/or whether the article and/or the loop alarm is attached a cable housing and/or a display stand.

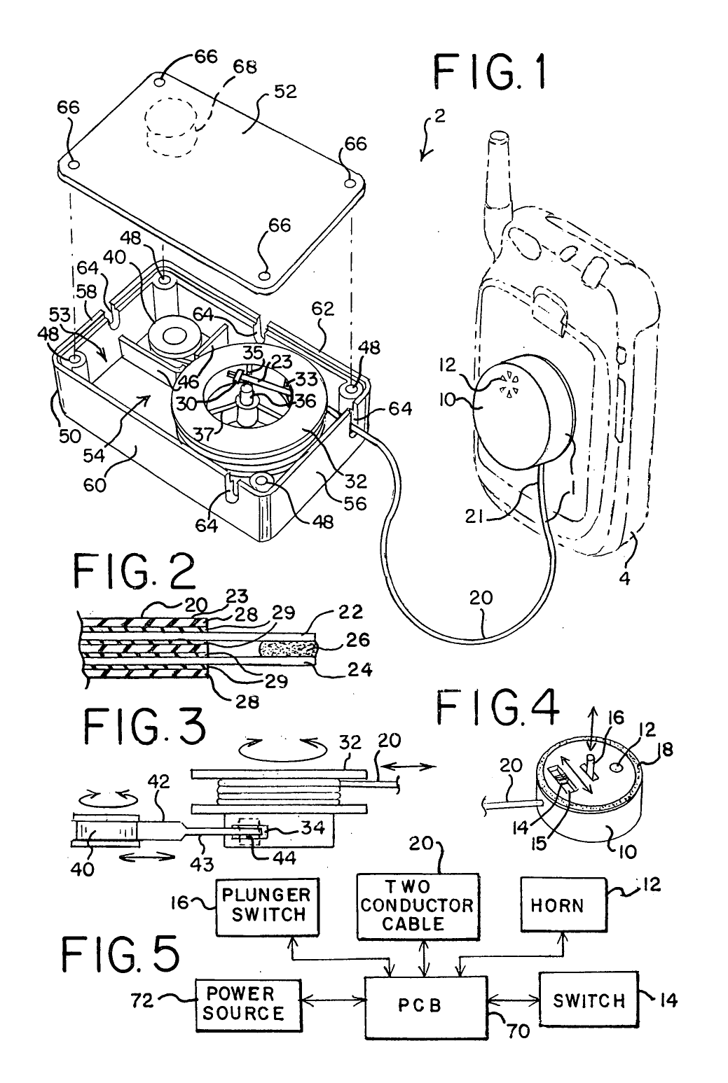

Referring now to the drawings wherein like numerals refer to like parts, FIGS. 1-4 illustrate an alarm apparatus 1, a system 2 and/or components of the apparatus 1 and/or of the system 2 for securing an article 4 in embodiments of the present invention. In an embodiment, the article 4 may be a portable electronic device, such as, for example, a cellular telephone, an mp3 player, a camera, a camcorder, a PDA, a gaming device, a handheld GPS system, a laptop computer, a satellite radio, a remote control, an e-book reader and/or the like. The article 4 may be on display and/or may be used, manipulated, tested and/or transported by consumers in an environment, such as, for example, a retail store. The present invention should not be deemed as limited to a specific embodiment of the article 4. It should be understood that the article 4 may be any article sold and/or displayed in an environment offering any article, product and/or other merchandise as known to one having ordinary skill in the art.

FIGS. 1 and 4 illustrate a loop alarm 10. The loop alarm 10 may be, for example, a housing and/or an enclosure for components and/or electronic equipment. The loop alarm 10 may have a horn 12 for providing an audible indicator during an alarm mode. The horn 12 may be any speaker and/or horn for producing an audible indicator, such as, for example, a piezoelectric speaker. In an embodiment, the loop alarm 10 may have a switch 14 that may enable and/or may disable the loop alarm 10. The switch 14 may be located in a slot 15 of the loop alarm 10. The switch 14 may be maneuvered into an on position and/or an off position by any object and/or other like member that may be sized to fit into the slot 15.

In an embodiment, the loop alarm 10 may have a plunger switch 16. The plunger switch 16 may be depressed by the article 4 when the loop alarm 10 is attached to the article 4. The plunger switch 16 may move to an extended position when the loop alarm 10 is removed from the article 4. The plunger switch 16 may arm the loop alarm 10 and may form a closed circuit when the plunger switch 16 is in a depressed position. When the plunger switch 16 is in the extended position, an open circuit may be formed.

In an embodiment, the loop alarm 10 may have an adhesive layer 18 that may attach the loop alarm 10 to the article 4 depressing the plunger switch 16. It should be understood that the loop alarm 10, the horn 12, the switch 14, the plunger switch 16 and/or the adhesive layer 18 may be any loop alarm, horn, switch, plunger switch and/or adhesive layer, respectively, as known to one having ordinary skill in the art.

FIG. 5 generally illustrates the components housed in, monitored by and/or controlled by the loop alarm 10. The loop alarm 10 may have a printed circuit board (hereinafter “PCB”) 70 that may monitor and/or control electrical components of the loop alarm 10. The loop alarm 10 may have an internal power source 72, such as, for example, a battery and/or the like. The PCB 70 may have a plunger sensing circuit (not shown) that may detect a position of the plunger switch 16. The loop alarm 10 may have a two conductor cable 20 electrically connected to the PCB 70. The horn 12 may be electrically connected to and/or controlled by the PCB 12. The switch 14 may be electrically connected to the PCB 70. It should be understood that the PCB 70, the internal power source 72 and/or the plunger sensing circuit (not shown) may be any PCB, internal power source and/or plunger sensing circuit, respectively, as known to one having ordinary skill in the art.

FIGS. 1-5 illustrate a two conductor cable 20. As shown in FIG. 2, the two conductor cable 20 may have two or more conductive wires 22, 24. The conductive wires 22, 24 may be housed in an insulating tube 28. The insulating tube 28 may shield the conductive wires 22, 24 from an external environment within which the conductive wires 22, 24 may be situated. The conductive wires 22, 24 may each have an insulating tube 29 that may insulate the conductive wires 22, 24 from each other to prevent a short circuit between the conductive wires 22, 24 within the insulating tube 28. At a first end 21 of the two conductor cable 20, the conductive wires 22, 24 may be electrically and/or mechanically connected to the loop alarm 10 and/or the PCB 70. At a second end 23 of the two conductor cable 20, the conductive wires 22, 24 may be electrically connected to form a closed circuit through the two conductor cable 20. The conductive wires 22, 24 may be electrically connected at the second end 23 of the two conductor cable 20 by a short 26, such as, for example a solder joint. It should be understood that the short 26 may be any electrical connection for electrically connecting conductive wires as known to one having ordinary skill in the art. Further, it should be understood that the two conductor cable 20, the conductive wires 22, 24, the insulating tube 28 and/or the insulating tube 29 may be any two conductor cable, conductive wires and/or insulating tube, respectively, as known to one having ordinary skill in the art. The present invention should not be deemed as limited to a specific embodiment of the two conductor cable 20.

As shown in FIG. 1, the two conductor cable 20 may be attached to a cable housing 50 at the second end 23 of the two conductor cable 20. In an embodiment, the cable housing 50 may have a first end 56 and a second end 58 in a position located opposite to the first end 56. The cable housing 50 may have a top end 60 and a bottom end 62. The bottom end 62 may be positioned at a location opposite to the top end 60. The cable housing 50 may have a backside 54 and a cover 52. The cover 52 may be located in a position opposite to the backside 54 and/or may be removed from the cable housing 50 to expose one or more internal components of the cable housing 50. The first end 56, the second end 58, the top end 60, the bottom end 62, the backside 54 and/or the cover 52 of the cable housing 50 may house a spool 32 that may rotate about a spool axle 36. The spool axle 36 may be integrally formed with and/or may extend from the backside 54 of the cable housing 50.

Further, the first end 56, the second end 58, the top end 60, the bottom end 62, the backside 54 and/or the cover 52 of cable housing 50 may house a spring 40. The spring 40 may rotate about an axis defined by the spring 40 within a spring housing 46. The spring housing 46 may be integrally formed and/or may extend from the backside 54, the second end 58 and/or the bottom end 62 of the cable housing 50. The cover 52 may have a spring positioner 68 that may hold the spring 40 in place between the cover 52 and the backside 54 within the spring housing 46. It should be understood that the cable housing 50 may be any housing as known to one having ordinary skill in the art. The present invention should not be deemed as limited to a specific embodiment of the cable housing 50.

The cable housing 50 may have one or more receivers 48 for fastening the cover 52 to the cable housing 50. The cover 52 may have one or more holes 66 that may receive one or more fasteners (not shown) for attaching the cover 52 to the receivers 48 of the cable housing 50. It should be understood that the fasteners may be any fasteners for attaching the cover to the housing as known to one having ordinary skill in the art. The present invention should not be deemed as limited to a specific embodiment of the receivers 48, the holes 66 and/or the fasteners.

As shown in FIG. 1, the second end 23 of the two conductor cable 20 may be attached to the spool 32. To connect the two conductor cable 20 to the spool 32, the cable housing 50 may have inputs 64 for receiving the two conductor cable 20 into an internal compartment 53 of the cable housing 50. The input 64 may be selected by a user of the system 2 based upon a desired position of inputting the two conductor cable 20 into the cable housing 50. The spool 32 may have a cutout 33 for receiving the second end 23 of the two conductor cable 20. The spool may have one or more spokes 37. The spool 32 may have a spoke notch 35 in one of the spokes 37 sized for receiving the second end 23 of the two conductor cable 20. The second end 23 of the two conductor cable 20 may be fastened to the spool 32 with a securing member 30. The securing member 30 may be secured to a perimeter of the second end 23 of the two conductor cable 20. The securing member 30 may be wider than a width of the spoke notch 35 of the spool 32. The user of the system 2 may position the securing member 30 adjacent to the spoke notch 35. As a result, the second end 23 of the two conductor cable 20 may, therefore, be fastened to the spool 32 and, therefore, the cable housing 50. It should be understood that the spool 32 and/or the fastening member 30 may be any spool and/or fastening member as known to one having ordinary skill in the art. The present invention should not be deemed as limited to a specific embodiment of the spool 32 and/or the fastening member 30.

The spring 40 may be, for example, a tape spring wound about the axis defined by the spring 40. As shown in FIG. 3, the spring 40 may have a taper 43 at a first end 42 of the spring 40. The spring 40 may have a tab 44 at the first end 42 of the spring 40. Also, as shown in FIG. 3, the spool 32 may have a fastening hole 34 that may receive the tab 44 of the first end 42 of the spring 40. The tab 44 of the spring 40 may secure the first end 42 of the spring 40 to the fastening hole 34 of the spool 32.

The two conductor cable 20 may be pulled outward with respect to the cable housing 50. Pulling the two conductor cable 20 may rotate the spool 32 in a first direction unwinding the two conductor cable 20 from the spool 32. As a result, the spring 40 may rotate in a direction opposite to the first direction unwinding the spring 40. While the spring 40 is being unwound, the spring 40 is loaded with a force. Unwinding the spool 32 and thus loading the spring 40 may create potential energy in the spring 40. After the force created by loading spring 40 exceeds any force placed on the spool 32 by pulling the two conductor cable 20, the spring 40 may unload winding the spool 32 in a second direction opposite to the first direction. The spring 40 may rotate in a direction opposite to the second direction. As a result, the two conductor cable 20 may be pulled by the user of the system 2 from the cable housing 50 allowing the user of the system to move the article 4 away from the cable housing 50. After the user has pulled the two conductor cable 20 from the cable housing 50, excess amounts of the two conductor cable 20 may be automatically rewound by the spring 40 and the spool 32 inside the cable housing 50. It should be understood that spring 40 and/or the fastening hole 34 may be any spring and/or fastening means, respectively, as known to one having ordinary skill in the art. The present invention should not be deemed as limited to a specific embodiment of the spring 40 and/or the fastening hole 34.

In an embodiment, as shown in FIG. 1, the user of the system 2 may desire to secure an article 4 to a display stand with a two conductor cable 20 stored in a cable housing 50 attached to the display stand. The user of the system 2 may desire to be alerted by the loop alarm 10 if either the loop alarm 10 is removed from the article 4 and/or if the two conductor cable 20 is cut and/or damaged. The user of the system 2 may also desire that the article 4 may be used, tested and/or manipulated by a user of the article 4 within a specified distance of the cable housing 50. The user of the system 2 may desire that an excess length of the two conductor cable 20 is distributed and/or retracted by the cable housing 50 before, during and/or after the article 4 is used, tested and/or manipulated by a consumer.

The user of the system 2 may activate the loop alarm 10 by maneuvering the switch 14 into the on position with any object and/or other like member that may be sized to fit into the slot 15 of the loop alarm 10. The user of the system 2 may attach the loop alarm 10 to the article 4 using the adhesive layer 18. While attaching the loop alarm 10 to the article 4, the plunger switch 16 may be depressed the article 4 creating a first closed circuit and thus arming the loop alarm 10. The conductive wires 22, 24 may be electrically connected by the short 26 at the second end 23 of the two conductor cable 20 to create a second closed circuit. Further, the second end 23 of the two conductor cable 20 may be attached to the spool 32 of the cable housing 50. The user of the system 2 may affix the cable housing 50 to the display stand to allow the consumer to interact with the article 4 at or near marketing information and/or sales information that may be related to or otherwise displayed by the article 4.

Before the consumer handles the article 4, the two conductor cable 20 may be wound and/or stored on the spool 32 within the cable housing 50. Typically, a majority of the two conductor cable 20 may be wound and/or stored on the spool 32 within the cable housing 50 before the consumer handles the article 4. The PCB 70 may use power from the internal power source 72 within the loop alarm 10 to monitor the system 2 for an open circuit. The open circuit may be created by removing the loop alarm 10 from the article 4 (extending the plunger switch 16). The open circuit may be created by cutting and/or by damaging one and/or more of the conductive wires 22, 24 within the two conductor cable 20. The consumer may use, test and/or manipulate the article 4 within a perimeter of the cable housing 50 defined by a length of the two conductor cable 20. It should be understood that the length of the two conductor cable 20 may be any operable length as known to one having ordinary skill in the art.

If the consumer removes the loop alarm 10 from the article 4, the plunger switch 16 may move to the extended position creating an open circuit. The PCB 70 may use power from the internal power source 72 within the loop alarm 10 to detect the open circuit that may activate the alarm mode. In the alarm mode, the PCB 70 may activate the audible indicator by sounding the horn 12 and/or may activate the visible indicator by powering a light source, such as, fore example, an LED. The sounding of the horn 12 and/or the powering of the light source may, in turn, alert security personnel.

If the consumer cuts and/or damages one or more of the conductive wires 22, 24 of the two conductor cable 20, an open circuit may be created. The PCB 70 may use power from the internal power source 72 within the loop alarm 10 to detect the open circuit that may activate the alarm mode. In the alarm mode, the PCB 70 ay activate the audible indicator by sounding the horn 12 and/or may activate the visible indicator by powering a light source. The sounding of the horn 12 and/or the powering of the light source ay, in turn, alert security personnel.

In the alarm mode, the audible indicator and/or the visible indicator may be produced from a location of the article 4 at a time that any open circuit may be created. As a result, security personnel may locate the article 4 and/or the consumer. During the alarm mode, the consumer may not be able to disable the loop alarm. As a result, the audible indicator and/or the visible indicator may remain activated. The consumer may not know how to disable the loop alarm during the alarm mode. Further, the consumer may not be able to maneuver the switch 14 into the off position because the consumer may not have access to an object and/or other like member that may be sized to fit into the slot 15. Moreover, the consumer may not be able to predict the size and/or the type of the object needed to fit into the slot 15. The slot 15 and/or the switch 14 may be unexposed while the loop alarm 10 is attached to the article 4 with the adhesive layer 18. In any event, the security personnel may disable the alarm mode by maneuvering the switch 14 of the loop alarm 10 into an off position with an object and/or other member that may be sized to fit into the slot 15.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An alarm apparatus for securing an article, the system comprising:
a loop alarm having an indicator, a switch, a two conductor cable and a printed circuit board wherein the indicator, the switch and the two conductor cable are electrically connected to the printed circuit board wherein the switch has a first position that forms a closed circuit wherein the loop alarm enters an alarm mode and activates the indicator when the switch is not in the first position; and
a cable housing having a cover that defines an interior wherein the two conductor cable retracts into the housing.

2. The alarm apparatus of claim 1 further comprising:
an on/off switch on the loop alarm wherein the on/off switch is recessed within a slot on the loop alarm wherein the on/off switch enables and disables the loop alarm.

3. The alarm apparatus of claim 1 wherein the indicator is an audible indicator that provides an audible signal.

4. The alarm apparatus of claim 1 wherein the indicator is a visible indicator that provides a visible signal.

5. The alarm apparatus of claim 1 further comprising:
an adhesive layer on the loop alarm wherein the adhesive layer attaches the loop alarm to the article.

6. The alarm apparatus of claim 1 wherein the switch is a plunger that is depressed in the first position.

7. The alarm apparatus of claim 1 further comprising:
an insulating tube around the two conductor cable.

8. The alarm apparatus of claim 1 further comprising:
a spool within the interior of the cable housing.

9. The alarm apparatus of claim 1 further comprising:
a spring within the interior of the cable housing.

10. The alarm apparatus of claim 1 further comprising:
a battery within the loop alarm wherein the battery provides power to the loop alarm.

11. A system for securing an article, the system comprising:
a loop alarm for monitoring an attachment of the loop alarm to the article and further wherein the loop alarm monitors an attachment of the loop alarm to a two conductor cable wherein the loop alarm enters an alarm mode when the loop alarm is detached from the article wherein the loop alarm enters an alarm mode when the two conductor cable is severed wherein the loop alarm produces an audible indicator associated with the loop alarm wherein the audible indicator provides an audible signal indicative of the alarm mode; and
a cable housing having a spool and a spring wherein a length of the two conductor cable between a first end of the two conductor cable and a second end of the two conductor cable is wound around the spool wherein the spring resists an unwinding of the length of the two conductor cable from the spool wherein the spring assists a winding of the length of the two conductor cable onto the spool.

12. The system of claim 11 further comprising:
a plunger on the loop alarm wherein the plunger is depressed during the attachment of the loop alarm to the article.

13. The system of claim 11 further comprising:
a horn on the loop alarm wherein the horn produces the audible indicator.

14. The system of claim 11 further comprising:
a switch on the loop alarm wherein the switch enables and disables the loop alarm.

15. The system of claim 11 further comprising:
a visual indicator that provides a visual signal indicative of the alarm mode.

16. The system of claim 11 further comprising:
a power source within the loop alarm.

17. A method for securing an article, the method comprising the steps of:
providing a loop alarm that monitors an attachment of the loop alarm to the article and an attachment of the loop alarm to a two conductor cable wherein the two conductor cable has a first end and a second end wherein the second end is in a position opposite to the first end forming a length of the two conductor cable wherein the first end of the two conductor cable is electrically connected to the loop alarm wherein the two conductor cable has a first conductive wire and a second conductive wire;
shorting the first conductive wire to the second conductive wire at the second end of the two conductor cable;
attaching the second end of the two conductor cable in a cable housing;
activating the loop alarm; and
attaching the loop alarm to the article.

18. The method of claim 17 further comprising the step of:
deactivating the loop alarm.

19. The method of claim 17 further comprising the step of:
winding the two conductor cable in the cable housing between the first end of the two conductor cable and the second end of the two conductor cable.

20. The method of claim 17 further comprising the step of:
providing power to the loop alarm.
